(19) United States
(12) Patent Application Publication
(10) Pub. No.: US 2013/0117052 A1
(43) Pub. Date: May 9, 2013

(54) System and Method for Reserving Unused Resources in a Controlled Admission Venue

(71) Applicant: Gregory Thane Wyler, Sewalls Point, FL (US)

(72) Inventor: Gregory Thane Wyler, Sewalls Point, FL (US)

(21) Appl. No.: 13/291,189

(22) Filed: Nov. 8, 2011

(51) Int. Cl. G06Q 10/02

(52) U.S. Cl. 705/5

(57) ABSTRACT

A system and method for a ticketing system to sell seating rights for a venue, wherein the method may include the steps of offering a ticket for sale by a ticketing system to the public; receiving an instruction to purchase a ticket to reserve a first seat in a venue for a specific event from a first customer at the ticketing system; upon receiving the purchasing instruction, the ticketing system offering an option to keep a second seat proximate to the reserved seat vacant in exchange for value from the first customer, in the event that no ticket for the second seat is sold prior to an occurrence of the specific event.

### BACKGROUND OF THE INVENTION

This invention relates in general to reserving resources in a venue and in particular to reserving potentially unused resources in a controlled-admission venue.

When reserving tickets on controlled-access vehicles such as airplanes, trains, or certain boats or for entertainment events, it is known for a customer to pay to reserve a specific seat for his or her own use. In certain environments however, the space available for the ticketed person himself/herself, and for the property of the ticket holder may be limited. Moreover, the degree of access to aisles for egress from a seating section or for access to desirable vantage point for viewing points of interest (such as a window seat on an airplane) may be dependent on factors other than the location of the seat purchased by the ticket holder, such as whether seats adjacent to the seat reserved by the ticket holder are empty or not. The level of comfort and sense of freedom from obstruction may also be affected by the proportion of all seats in the pertinent venue that are sold prior to a pertinent event at the venue, such as the flight of an airplane or a concert at an auditorium. Thus, a fully sold out airplane flight, or entertainment event may end up impacting the enjoyment and/or utility of the ticket holder's experience within the controlled-access venue.

Thus, it is a problem in the art that some aspects of the experience of a ticket holder for an event or flight to which the ticket holder has purchased access may be impacted by events beyond the ticket holder's control.

### SUMMARY OF THE INVENTION

According to one aspect, the invention is directed to a system and method for a ticketing system to sell seating rights for a venue, wherein the method may include the steps of offering a ticket for sale by a ticketing system to the public; receiving an instruction to purchase a ticket to reserve a first seat in a venue for a specific event from a first customer at the ticketing system; upon receiving the purchasing instruction, the ticketing system offering an option to keep a second seat proximate to the reserved seat vacant in exchange for value from the first customer, in the event that no ticket for the second seat is sold prior to an occurrence of the specific event.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram of a portion of a seating chart for an airplane in accordance with an embodiment of the present invention;

FIG. 2 is a schematic representation of a seating reservation system in accordance with an embodiment of the present invention;

FIG. 3 is a block diagram of one sequence of events for enabling one or more customers to bid on an option to preserve the vacancy of one or more seats within a venue in which a customer has reserved a seat, in accordance with an embodiment of the present invention;

FIG. 4 is a table showing a priority order in which non-reserved seating is available for reservations in accordance with an embodiment of the present invention; and

FIG. 5 is a block diagram of a computer system useable in conjunction with one or more embodiments of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

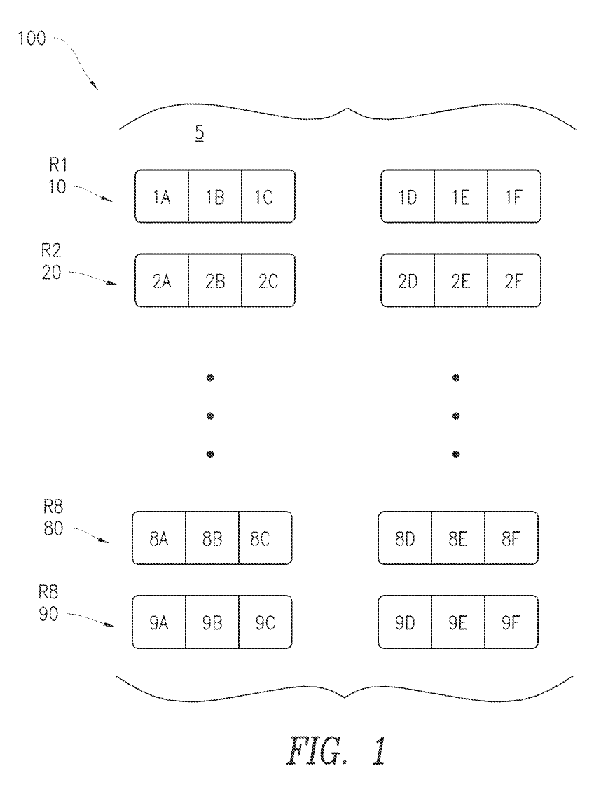

FIG. 1 shows a seating chart of an exemplary airplane having nine rows and six seats per row, separated into two seating banks in each row. For the sake of convenience, only four of the nine rows are shown. Specifically, FIG. 1 shows row 1 10, row 2 20, row 8 80 and row 9 90, with each row having seats identified using two characters, the first of which is the numeral corresponding to the row number the seat is in and the second character corresponding to the position of the seat along the lateral dimension of the airplane. Thus, the seating chart includes seats: 1A, 1B, 1C, 1D, 1E, 1F, and so forth for rows 2, 8, and 9. The various seats are found within seating section 5 which is within airplane 100.

It will be appreciated that the principles of the invention disclosed herein may be applied to airplanes and other types of vehicles (such as buses, trains, and boats) or other venue, fixed or mobile, having more or fewer than nine rows, having more or fewer than six seats per row, and where applicable to vehicles having seating on more than level of the vehicle, and all such variations are intended to be included within the scope of the invention.

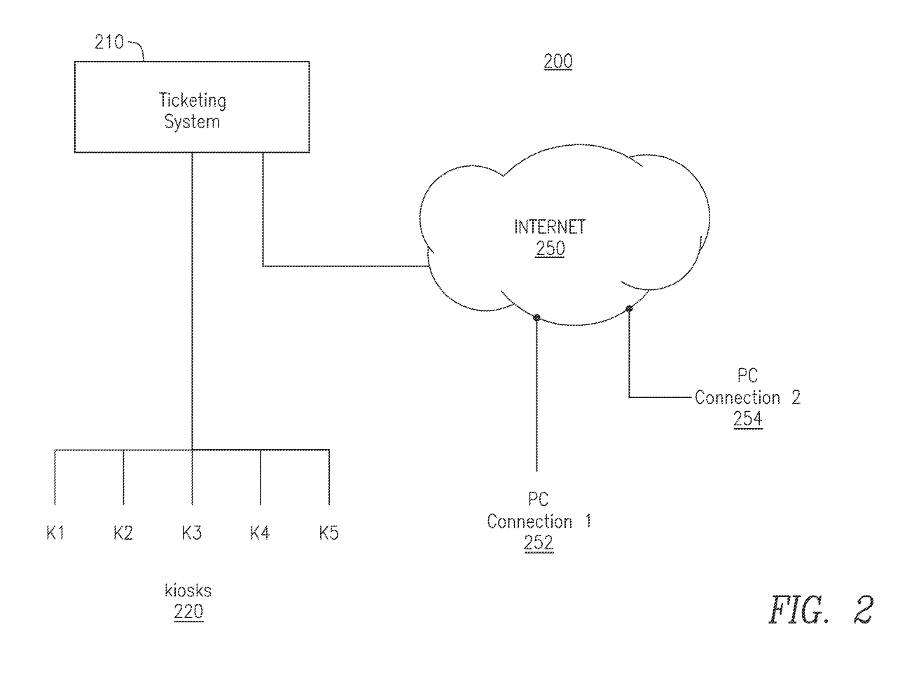

FIG. 2 is a schematic representation of a seating reservation system 200 in accordance with an embodiment of the present invention. Reservation system 200 may include ticketing system 210, a plurality of ticketing kiosks 220, PCs (personal computers) 252, 254 that may be in communication with ticketing system 210 via Internet 250.

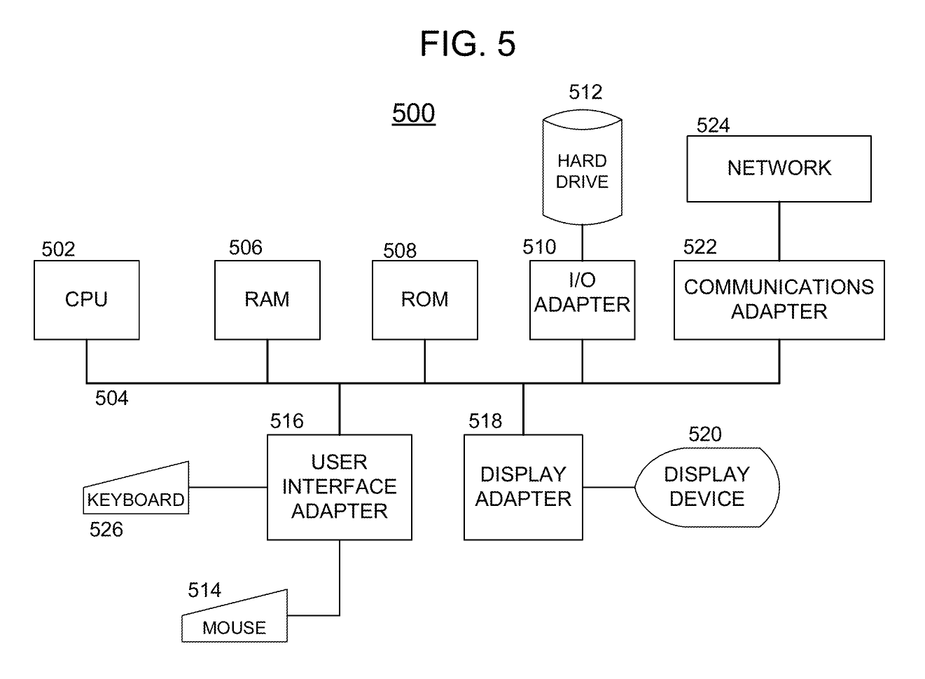

Ticketing system 210 may include one or more computer systems such as the one depicted in FIG. 5 herein, computer storage devices, and public and/or proprietary communication links for enabling communication between ticketing system 210 and customers using a variety of possible devices for conducting ticketing transactions. Kiosks 220 may include kiosks K1 through K5, as shown in FIG. 2. Kiosks 220 may include any number of kiosks suitable for the needs of reservation system 200. Each kiosk K# may include computing equipment (such as a personal computer), display equipment such as a computer monitor, user data input equipment such as a keyboard or touch-screen monitor for enabling a user to enter data to make a reservation, make a payment to ticketing system 210, or conduct any other pertinent transaction. System 200 may include any number of PCs such as PCs 252 and 254, including a number of such devices in excess of two, as needed. PCs 252 and 254 may enable users with access to the Internet 250 to conduct any needed transactions with ticketing system 210 to complete seat reservations as contemplated by one or more embodiments of the invention. PCs 252, 254 may include any device capable of conducting communication over a wired or wireless internet connection including traditional desktop personal computers, notebook computers, tablet computers, smartphones, or other devices equipped with suitable computing and communication means.

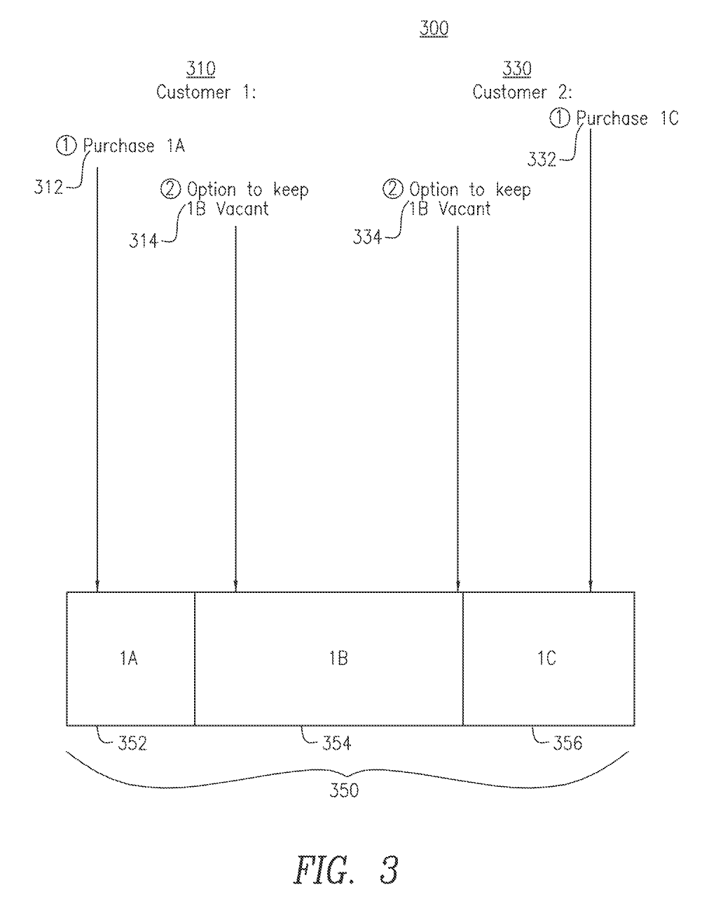

FIG. 3 is a block diagram of one sequence of events 300 for enabling one or more customers to bid on an option to preserve the vacancy of one or more seats within a venue in which a customer has reserved a seat, in accordance with an embodiment of the present invention.

Embodiments of the present invention generally directed to enabling a customer for admission to a venue (which may be a vehicle, an entertainment venue, or any other controlled-access environment), such as an airplane to supplement the purchase of a right to occupy a seat (or corresponding type of space in another type of venue) with a right to preserve the vacancy of a seat that is either adjacent to the seat the customer has purchased a right to occupy, or merely proximate to the customer-occupied seat.

For example, in one embodiment which will be discussed in connection with FIG. 3, a customer who wishes to purchase a ticket to reserve and ultimately occupy a window seat on an airplane may prefer, if possible, to have the middle seat (which for this example is presumed to be adjacent to the window seat) remain vacant for the purposes of comfort, convenience (i.e. to store possessions), and/or other purpose. In existing practice, the fate of the middle seat being either occupied or vacant is essentially random from the vantage point of the purchaser of the window seat. An embodiment herein is directed to enabling the purchaser of the window seat (or other venue admission right) to pay value for the opportunity to preserve the vacancy of a seat proximate to the reserved window seat, which includes a middle seat adjacent to the reserved window seat. Preferably, the option to preserve the vacancy of a seat proximate to a seat reserved is made available at a price lower than the cost of purchasing a regular ticket for the proximate seat. This arrangement will generally be beneficial to ticketing system 210, and any corporate entity associated with ticketing system 210 only if no ticket to the middle seat at issue could have been sold for the pertinent flight of airplane 100. For ease of reference below, the hypothetical flight for which tickets are being purchased is referred to as flight #1.

As stated above, while one embodiment of the present invention is directed to purchasing an option to have a seat adjacent to a reserved seat remain vacant, other degrees of relation between the reserved seat and the seat for which vacancy is sought may be desired by customers and may thus be practiced. For instance, instead of being immediately adjacent to the seat being reserved, the seat for which vacancy is sought could two more seats away from the reserved seat, within the same row, which might enable a customer to reserve an entire bank of seats for lying down or other desirable purpose. In another case, the seat for which vacancy is sought could be in a different row from the reserved seat. For example, where the venue is an entertainment event, such as a playhouse or movie theatre, a customer with a reserved seat may wish to have a vacant seat one row closer to the stage or screen than the reserved seat to improve visibility by the customer from the reserved seat. Moreover, other variations on the theme discussed above will be apparent to those having ordinary skill in the art, and all such variations are intended to be included within the scope of the present invention.

Having discussed the above possible variations of the embodiments presented herein, we now turn to the specific embodiment shown in FIG. 3. FIG. 3 shows a seat reservation scenario 300 which includes customer 1 310, customer 2 330, a bank 350 of seats including window seat 1A 352, middle seat 1B 354, and aisle seat 1C 356. Bank 350 of seats 1A/1B/1C is an enlarged view of a portion of the seating chart of FIG. 1.

In the example of FIG. 3, customer 1 310 preferably conducts a transaction with ticketing system 210 (FIG. 2) for the purchase of seating rights within airplane 100. At step 312, customer 1 312 customer 1 310 may submit an instruction to ticketing system 210 to purchase a ticket to reserve seat 1A 352, for value, for a particular flight. Upon receiving the instruction in step 312, ticketing system 210 may offer customer 1 310 the option of pursuing still further seating rights within airplane 100, for flight #1.

In this embodiment, ticketing system 310 may offer customer 1 310 one or more additional seating rights within airplane 100 for the flight #1. Specifically, ticketing system 210 may offer customer 1 310 the option of keeping middle seat 1B 354 vacant, so long as the exercise of this option does not reduce the total number of tickets sold on airplane 100 flight #1. For instance, ticketing system 210 could offer customer 1 310 the option to keep seat 1B 354 vacant in exchange for a possible future payment of $50 from customer 1 310 to ticketing system 210, or to another suitable entity affiliated with ticketing system 210. It will be understood that the present invention is not limited to any particular payment amount. The cost of keeping seat 1B 354 vacant could be higher or lower than $50. In this embodiment, the $50 paid by customer 1 310 to keep seat 1B 354 vacant may be kept in reserve until ticketing system 210 knows for certain that seat 1B will remain vacant for flight #1.

In a manner similar to the above, ticketing system 210 may offer customer 2 330 an option for the same middle seat 1B which customer 1 310 paid to keep vacant. Specifically, customer 2 330 may conduct a transaction with ticketing system 210 to purchase a ticket for aisle seat 1C 356 for flight #1. Once the purchase of a ticket for seat 1C for flight #1 is complete, ticketing system 210 may offer customer 2 330 the option of keeping seat 1B vacant. Ticketing system 210 may offer the vacancy option to customer 2 330 for $50. Thus, under this approach, if both customer 1 310 and customer 2 330 both pay to keep seat 1B vacant, and the demand for flight 1 is such that seat 1B is in fact kept vacant on flight 1, ticketing system 210 may collect a total of $100 from customer 1 310 and customer 2 330 in exchange for the vacancy of seat 1B. In an alternative embodiment, the total cost to customers 310 and 330 could be reduced from $100 to some lower amount to incentivize the customers to ensure the vacancy of seat 1B. If a ticket for middle seat 1B 354 is ultimately sold for flight #1, any money received by ticketing system 210 is preferably returned to customer 1 310 and/or customer 2 330.

### Prioritization of Seats Subject to Vacancy Requests

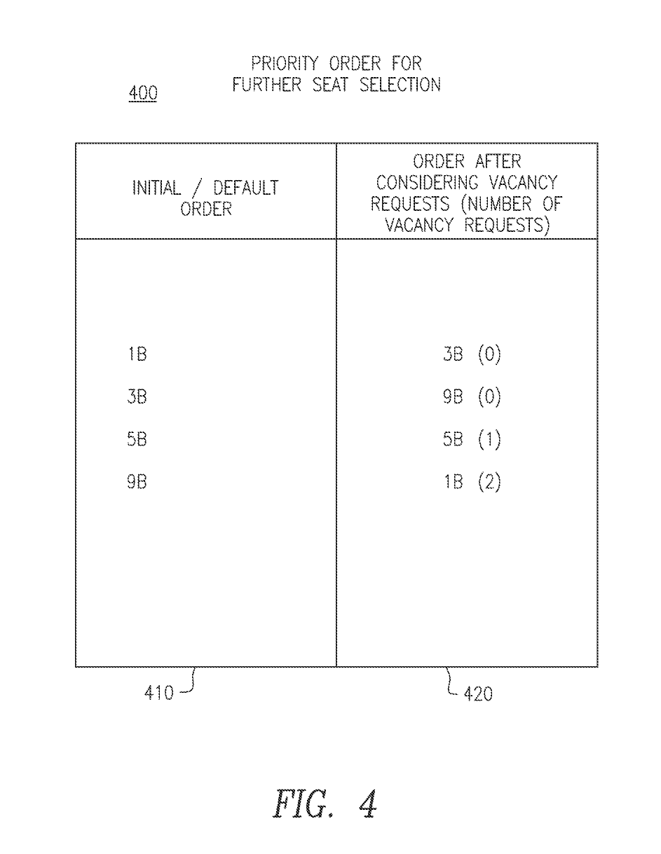

FIG. 4 is a data table showing a priority order in which non-reserved seating is available for reservations in accordance with an embodiment of the present invention. FIG. 4 and the below discussion thereof is directed to showing how requests for preserving the vacancy of one or more seats within airplane 100 for flight #1 impacts the availability of seating for customers who contact ticketing system 210 after vacancy requests have been entered for one or more seats in airplane 100. Column 1 410 shows an initial, default ordering of the availability of seats in airplane 100 that have so far not been reserved. Column 2 420 shows a priority ordering of non-reserved seats after vacancy requests have been processed by ticketing system 210. The numbers in parentheses following the seat numbers in column 2 420 correspond to the number of vacancy requests associated with the listed seat number. Data for table 400 of FIG. 4 may be stored on a data storage device at ticketing system 210, or alternatively on a data storage device elsewhere which is in communication with ticketing system 210.

Turning to column 1 410, the priority order of non-reserved seats as they may be selected by ticketing system 210 in response to a customer enquiry is 1B, 3B, 5B, and 9B. For the sake of discussion herein, it has been assumed that the default ordering of non-reserved seats starts with the lowest numbered row and proceeds from there to the highest-numbered row. However, the principles of the present invention are not limited to this initial priority ordering scheme, and may be applied regardless of what default ordering is used.

For the sake of the example shown in FIG. 4, seat 1B has two vacancy requests, seat 5B has one vacancy request, and seats 3B and 9B have no vacancy requests. What results from this is the priority order of non-reserved seats shown in column 2 420, with the number of vacancy requests associated with the seats shown within parentheses after each seat number in column 2 420. It is assumed that, for seats having no vacancy requests, the default ordering system is applied. Thus, seat 3B is listed before seat 9B due to seat 3B being in a lower-numbered row than seat 9B.

We now consider how ticketing system 210 may handle seat reservation requests after taking the vacancy requests into account. With reference to column 2 420, it may be seen that the seats with vacancy requests associated therewith (i.e. seats 1B and 5B) have been moved to the bottom of the priority order list, while seats 3B and 9B are at the top of the list. Thus, when a new customer requests an available seat that matches the characteristics of the seats listed in column 2 420, ticketing system 210 preferably presents seat 3B to the customer as the first choice. In this manner, unless there is a preference for one of the middle seats (in the embodiment discussed herein, seat numbers ending in “B” are middle seats) other than the seat at the top of the priority list, ticketing system 210 is able to both (a) sell the additional seat (in this case seat 3B) and (b) sell the vacancy of seat 1B. The above may enable ticketing system 210 to derive an economic benefit merely by re-ordering the priority of seating that has not yet been reserved by other customers, by maintaining the vacancy of seat 1B, but without reducing the total number of tickets sold for flight #1 of airplane 100.

In one embodiment, if a customer (a “later customer”) dealing with ticketing system 210 after the above discussed first and second customers requests a particular middle seat, such as seat 5B, instead of requesting a middle seat in general, ticketing system 210 may offer the later customer an incentive to pick a middle seat that does not have a vacancy request associated therewith. For example, ticketing system 210 could be configured to work toward preserving the right to collect $50 from the customer having requested that seat 5B remain vacant, and still collect a full fare from the later customer, by offering the later customer a $10 incentive to select seat 9B instead of seat 5B. In an alternative embodiment, seats having vacancy requests associated therewith could be flagged as unavailable by ticketing system 210 so that no such conflict arises.

In an embodiment, the option to reserve the vacancy of a seat proximate or adjacent to a reserved seat may be offered and/or exercised anytime after the purchase of a ticket for the reserved seat. For example, a customer 310 may purchase a ticket to reserve seat 1A on given day, such as Mar. 1, 2012, for a flight #1 occurring on Mar. 15^{th}, 2012. Ticketing system 210 may offer the option of preserving the vacancy of seat 1B and/or another seat in seating section 5 of airplane 100, any time after the purchase of the ticket for seat 1A, up to the time of flight #1.

According to one aspect, embodiments of the present invention are directed to systems and methods for managing the placement of passengers in an aircraft, or other controlled-access venue, which systems and methods thus form part of operating the aircraft. More particularly, one or more embodiments of the present invention may be directed to managing the location of empty seats in an aircraft, or other venue such as a stadium or auditorium. While much of the disclosure herein is directed to the benefits of passenger comfort and convenience arising from managing the location of empty seats in a passenger aircraft, and/or other venues, other benefits may obtained by practicing the concepts disclosed herein. For instance, for a flight by an airplane that is only partially booked (i.e. which has a significant number of vacant seats), suitable control of the placement of the passengers, and thus of the locations of the vacant seats, within the seating area(s) may be operable to aid the operation of the aircraft such as by maintaining a more beneficial fore-aft and/or left-to-right balance of the craft, by aiding aircraft personnel in managing the distribution of products (such as refreshments) and/or services to the passengers, and/or by managing the flow of passengers through the craft during emergency exit maneuvers, or other movements of passengers into or out of the airplane.

FIG. 5 is a block diagram of a computing system 500 adaptable for use with one or more embodiments of the present invention. Central processing unit (CPU) 502 may be coupled to bus 504. In addition, bus 504 may be coupled to random access memory (RAM) 506, read only memory (ROM) 508, input/output (I/O) adapter 510, communications adapter 522, user interface adapter 506, and display adapter 518.

In an embodiment, RAM 506 and/or ROM 508 may hold user data, system data, and/or programs. I/O adapter 510 may connect storage devices, such as hard drive 512, a CD-ROM (not shown), or other mass storage device to computing system 500. Communications adapter 522 may couple computing system 500 to a local, wide-area, or global network 524. User interface adapter 516 may couple user input devices, such as keyboard 526, scanner 528 and/or pointing device 514, to computing system 500. Moreover, display adapter 518 may be driven by CPU 502 to control the display on display device 520. CPU 502 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for a ticketing system to sell seating rights for a venue, the method comprising the steps of:
offering a ticket for sale by a ticketing system to the public;
receiving an instruction to purchase a ticket to reserve a first seat in a venue for a specific event from a first customer at the ticketing system;
after receiving said purchasing instruction, the ticketing system offering an option to keep a second seat proximate to said reserved seat vacant in exchange for value from said first customer, in the event that no ticket for said second seat is sold prior to an occurrence of the specific event.

2. The method of claim 1 further comprising:
receiving an instruction from the first customer to purchase the option to keep said proximate seat vacant.

3. The method of claim 2 wherein said the venue is an airplane and the specific event is a flight of the airplane.

4. The method of claim 3 wherein the adjacent seat is a middle seat within a bank of seats within the airplane.

5. The method of claim 1 wherein the venue is an entertainment complex.

6. The method of claim 5 wherein the seat proximate to the reserved seat is one row closer to an event stage in the entertainment complex than the reserved seat.

7. A method for a ticketing system to sell seating rights for a flight on an airplane, the method comprising the steps of:
offering a ticket for sale by a ticketing system to the public;
receiving, at the ticketing system, an instruction to purchase a ticket to reserve a first seat in the airplane for a specific flight from a first customer;
after receiving said purchasing instruction, the ticketing system offering an option to keep a second, middle seat adjacent to said reserved first seat vacant in exchange for value from said first customer; and
receiving an instruction, at the ticketing system, from the first customer to purchase the option to keep said middle seat vacant.

8. The method of claim 7 further comprising:
keeping said middle seat vacant for said specific flight only if no ticket for said adjacent seat is sold prior to said specific flight.

9. The method of claim 7 further comprising:
the ticketing system selling a ticket for a third seat adjacent said middle seat to a second customer.

10. The method of claim 9 further comprising:
the ticketing system offering an option to said second customer to keep said middle seat adjacent to said reserved first seat vacant in exchange for value from said second customer.

11. The method of claim 10 further comprising:
reimbursing the first and second customers for any value paid for said options to keep the middle seat vacant only if a ticket for the middle seat for said specific flight is sold prior to said specific flight.
